(19) United States
(12) Patent Application Publication
(10) Pub. No.: US 2006/0266592 A1
(43) Pub. Date: Nov. 30, 2006

(54) Compact bedplate with integrated, accessible dead end hitches

(76) Inventors: Andes Monzon, Madrid (ES); Jose Canales, Madrid (ES); Fernando Del Rio, Madrid (ES); Francisco Sanz, Madrid (ES); Leandre Adifon, Farmington, CT (US)

Correspondence Address: Theodore W Olds;Carlson Gaseky & Olds, Suite 350, 400 W Maple Road, Birmingham, MI, 48009, US

(21) Appl. No.: 10/561,557

(22) PCT Filed: Jun. 20, 2003
(86) PCT No.: PCT/US03/19503

§ 371 Date: Dec. 19, 2005

(51) Int. Cl. B66B 7/10

(52) U.S. Cl. 187/412

(57) ABSTRACT

An improved elevator mounts its dead end hitches (38A, 38B, 38C and 40A, 40B, 40C) on the bedplate (46, 48) of a machine roomless elevator. The dead end hitches are preferably positioned on an upper surface of the bedplate such that they are easily accessible. Further, the governor (80) is mounted adjacent the machine (24) on the bedplate. Preferably, there are a plurality of dead end hitches and a plurality of connecting members connecting the car and counterweight. The plurality of dead end hitches are preferably aligned along lines (A and B) which are parallel to a drive axis of the drive sheave (30). Further, the plural connecting members are preferably each associated with a surface on a drive sheave and a pair of dead end hitches. A line drawn through a sheave surface and its two associated dead end hitches would be perpendicular to the rotational drive axis.

### BACKGROUND OF THE INVENTION

This application relates to an elevator having its machine mounted on a bedplate and its dead end hitches extending vertically above a lowermost surface of the bedplate. Also, the dead end hitches are aligned in a space efficient manner.

Elevators typically include an elevator car and a counterweight connected by several tension or connecting members such as ropes or belts. A machine drives the connecting members to move the counterweight and car through a hoistway.

Historically, the machine was mounted in a room above the hoistway known as a machine room. This required a good deal of additional space. More recently elevators have been developed which incorporate the machine into the space between the car and an opposed wall. With such an arrangement, there is no machine room necessary. This type of elevator is generally known as a “machine roomless” elevator.

In one known type of machine roomless elevator, the machine is mounted on a bedplate. The ends of the connecting members, or the “dead end hitches” are attached to the bottom of the bedplate. With this proposed arrangement, the dead end hitches are not easily accessible. Moreover, the arrangement of the dead end hitches is not as space efficient as would be desired.

### SUMMARY OF THE INVENTION

In a disclosed embodiment of this invention, dead end hitches are provided in a machine roomless elevator at a location above a lowermost point on the bedplate. In one embodiment, the dead end hitches are provided on top of the bedplate and next to the machine. In another embodiment, the dead end hitches are provided within an interior space in the bedplate. At either location, the dead end hitches are more easily accessible than in the prior art. Further, mounting the dead end hitches on the bedplate vertically above the lowermost point on the bedplate provides better space utilization, and also does not require numerous additional parts.

In a separate inventive feature, the dead end hitches are preferably aligned parallel to a rotational axis of the machine. There preferably are two aligned rows of dead end hitches, each defining a line parallel to the machine rotational axis. In this way, the tension or connecting members which are used to connect the utilized.

In another inventive feature, a drive sheave for driving the connecting members has surfaces associated with each of the connecting members. The surfaces are axially aligned with associated dead end hitches at the ends of the particular connecting member. A line drawn through a sheave surface and its two associated dead end hitches is preferably perpendicular to the rotational axis of the machine.

These and other features of the present invention can be best understood from the following specification and drawings, the following of which is a brief description.

### BRIEF DESCRIPTION OF THE DRAWINGS

FIG. 1 schematically shows an elevator.

FIG. 2 shows a portion of an elevator drive assembly.

FIG. 3 is a top view showing the inventive bedplate.

FIG. 4 is a partially schematic overhead view.

FIG. 5A is a cross-sectional view through an inventive bedplate.

FIG. 5B is a cross-sectional view through an inventive bedplate with an alternative dead end hitch

FIG. 6 shows an alternative placement for a dead end hitch.

FIG. 7 is a cross-sectional view showing another embodiment.

### DETAILED DESCRIPTION OF THE PREFERRED EMBODIMENTS

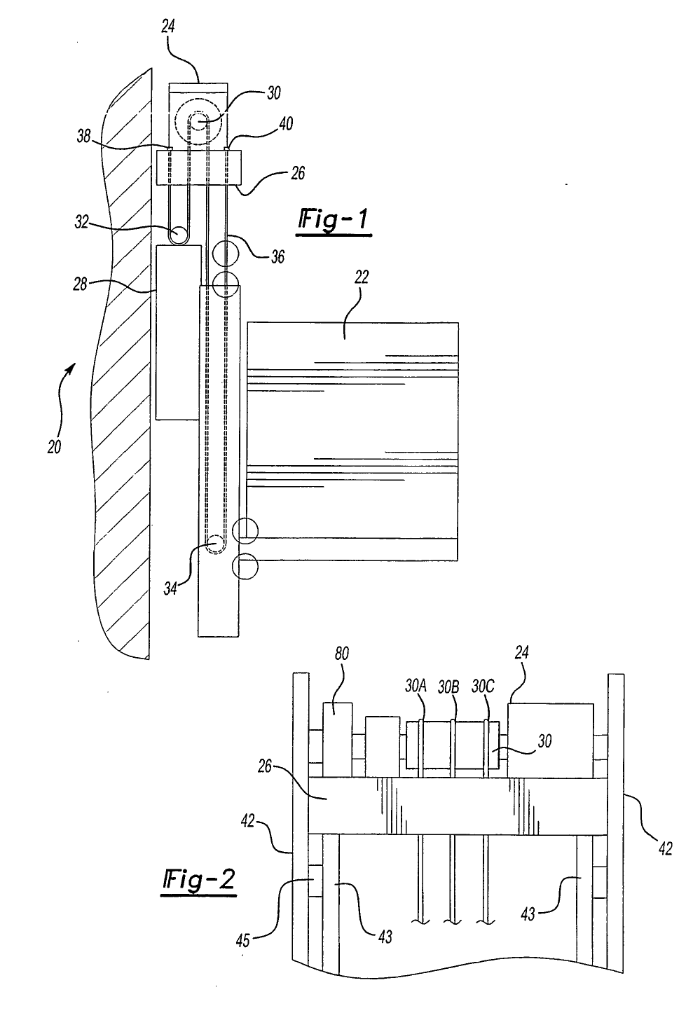

An elevator 20 is illustrated in FIG. 1 having an elevator car 22 movable through a hoistway. A machine 24 drives the car 22 in combination with a counterweight 28. The machine 24 is mounted on a bedplate 26. Bedplate 26 is mounted between a pair of spaced rails 42 for guiding the car 22, and another pair of spaced rails 43 for guiding counterweight 28 (see FIG. 2). The rails 42 and 43 are typically provided by separate guide rail elements interconnected by connecting structures such as shown at 45. Integral, or one-piece rails, would also come within the scope of this invention. A sheave 30 associated with the machine 24 drives a connecting member such as a rope or belt 36 which also extends around a sheave 34 associated with the car 22 and another sheave 32 associated with the counterweight 28.

As known, opposed ends of the connecting member 36 are attached at dead end hitches 38 and 40. As is illustrated schematically in this view, the dead end hitches 38 and 40 are on an upper surface of the bedplate 26.

As shown in FIG. 2, the rails 42 and 43 support the bedplate 26. As can be appreciated, while FIG. 1 schematically shows a single connecting member 36, in practice, there may be several. The bedplate 26 supports the machine 24, sheave 30 having three sheave surfaces 30A, 30B, 30C to receive connecting members, and a speed governor 80. The sheave surfaces 30A, 30B and 30C may be grooves or other surfaces to receive the connecting members. Notably, bedplate 26 is preferably attached to all four guide rails 42 and 43.

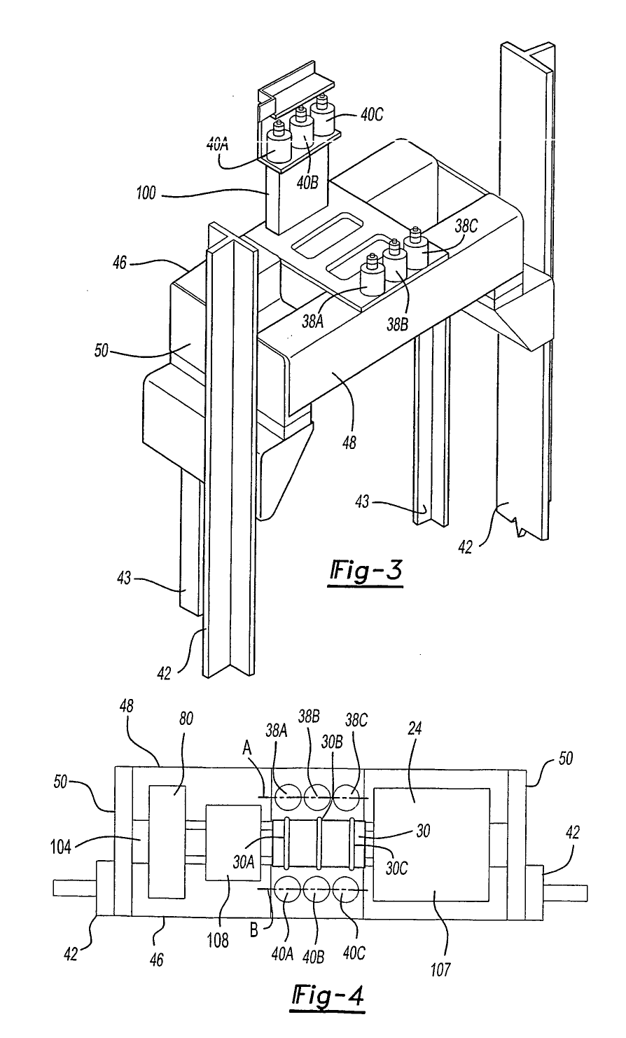

FIG. 3 is a perspective top view of the bedplate 26, omitting the machine. The embodiment illustrated in FIG. 3 shows three spaced dead end hitches 38A, 38B, 38C for attaching one end of each of three connecting members 36 and three other dead end hitches 40A, 40B and 40C for the opposed ends of the connecting members. As can be appreciated from this figure, a spacer element 100 extends the dead end hitches 40A, 40B and 40C vertically above the vertical location of the dead end hitches 38A, 38B and 38C. The spacer element 100 preferably moves the dead end hitches 40A, 40B, 40C most remote from the car to a vertically upward position. The machine 24 and the sheave 30 are positioned between the dead end hitches 40A, 40B and 40C and the hoistway. Thus, the dead end hitches 40A, 40B, and 40C are somewhat less accessible than the dead end hitches 38A, 38B and 38C. The spacer element 100, which moves the dead end hitches 40A, 40B and 40C vertically upwardly increases the accessibility.

The structure of the dead end hitches is generally as known, and thus is not specifically detailed within this application. As generally known, ends of the connecting member are held at a termination, which would be below the bedplate 26 in this figure. A rod extends from the termination upwardly to the dead end hitches. The hitch can be provided by either a spring, a rubber block or other resilient member. Generally, these features of the invention are as known in the prior art.

As also shown in FIG. 3, the bedplate is formed of two opposed C-shaped cross-section beams 46 and 48. End plates 50 connect the ends of the beams 46 and 48.

As shown in FIG. 4, a top view of the bedplate 26 shows there is a space 104 between the two C-shaped beams 46 and 48. As shown in this figure, the dead end hitches 40A, 40B and 40C are aligned into a row extending along a line B, whereas the dead end hitches 38A, 38B and 38C are aligned into a row extending along a line A. The lines A and B are parallel to each other, and are also parallel to a rotational axis of the sheaves 30 and sheave surfaces 30A, 30B and 30C. In this manner, the connecting members are less likely to twist than has been the case in the prior art, wherein the axes of the dead end hitches and the sheaves may sometimes be positioned skew relative to each other. Moreover, space is more efficiently utilized. As shown in this figure, the dead end hitches are positioned axially aligned with respective sheave surfaces 30A, 30B, 30C. Stated another way, an axial distance could be defined between the motor portion 107 and the axially most distant end of the sheave 30. As illustrated here, each of the dead end hitches 38A, 38B, 38C, 40A, 40B, and 40C are within this axial distance. Moreover, one of the dead end hitches 38 is preferably axially aligned with one of the sheave 30 surfaces and one of the dead end hitches 40. Preferably, there are three such aligned groups as illustrated in FIG. 4. A line drawn through each group is perpendicular to the rotational axis of the sheave 30. In this manner, the space above the bedplate is more efficiently utilized. As can be appreciated from FIG. 4, the machine 24 has an enlarged motor portion 107 and a spaced enlarged portion 108, which may be a brake and part of a bearing supporting the drive shaft for driving sheave 30. The outer diameters of the sheave is not as large as the elements 107 or 108. Thus, positioning the dead end hitches 38A, 38B and 38C, and 40A, 40B and 40C at positions axially aligned with the sheave provides better space utilization. Also, governor 80 is supported on the bedplate.

The above features are particularly valuable when the connecting member utilized is a so-called “flat rope.” In elevators utilizing such connecting members, the specifically mentioned arrangements of the dead end hitches relative to the sheave surfaces provide benefits in preventing twisting, etc.

In the most preferred embodiment, both the parallel lines A and B, and the axial alignment of each sheave surface and its associated dead end hitches are combined. However, the features may also be utilized independent of each other. As an example, the axial alignment of the sheave surface and its associated dead end hitches relative to the rotational axis of the sheave may be utilized without the parallel alignment along lines A and B. The dead end hitches could be instead staggered relative to each other, etc. Further, it is also possible that there could be sheaves on each side of the machine associated with respective connecting members. Here again, both the “parallel” and “perpendicular” features as mentioned above could be incorporated to provide the mentioned benefits.

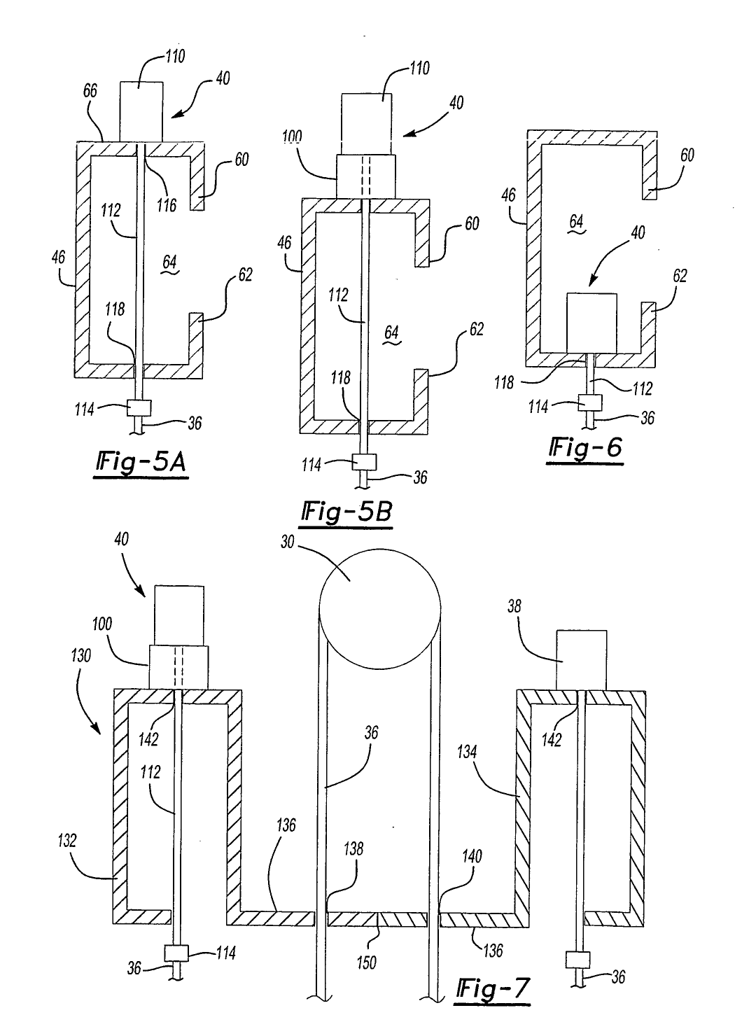

As shown in FIG. 5A, the dead end hitches 40 (and the other dead end hitches 38, not illustrated) are positioned atop a top wall 66 of the beam 46. As shown, the C-shape is provided by inwardly extending flanges 60 and 62 creating an internal space 64. Since the dead end hitch is positioned above the uppermost surface 66 of the bedplate 26, the dead end hitch is easily accessible for servicing. In the prior art, the proposed dead end hitches mounted to a bedplate have been positioned beneath the bedplate, and would be less easily accessible.

As shown schematically, and as known, a dead end hitch includes a portion 110 such as a rubber block, or spring, receiving a rod 112 that extends to a termination 114. The termination 114 secures connecting member 36 to the rod 112. As can be appreciated from FIG. 5A, the rod extends through holes 116 and 118 in the beam 46.

FIG. 5B shows a similar arrangement for dead end hitch 40, but wherein a spacer element 100 positions the block 110 somewhat vertically higher than in the FIG. 5A embodiment. Again, while a rubber block 110 is illustrated, a worker in this art recognizes that other forms of dead end hitches may be utilized, and would come within the scope of this invention.

FIG. 6 shows another embodiment wherein the dead end hitch 40 is mounted within the space 64. While this embodiment may be somewhat less accessible, it does provide good space utilization, and at the same time additional protection for the dead end hitch. The hitch is shown schematically.

FIG. 7 shows an embodiment wherein a bedplate arrangement 130 includes a pair of spaced side portions 132 and 134 supporting the hitches 40 and 38. As shown, central plate portions 136 extend from each side portion 132 and 134. The sheave 30 has the connecting member 36 extending through openings 138 and 140 in the central plate portions 136. The central plate portions meet at a butt welded joint 150. Openings 142 are formed in side portions 132 and 134. End plates and stiffeners may be used to provide structural integrity.

It should also be understood that while specific bedplate structures have been illustrated, many other bedplate shapes and arrangements would come within the scope of this invention. As an example, the bedplate may simply be a flat plate.

Further, while each of the dead end hitch embodiments are shown mounted to the bedplate, a dead end hitch mounted vertically above the bedplate, but not connected to the bedplate, may also come within the scope of this invention.

Although preferred embodiments of this invention has been disclosed, a worker of ordinary skill in this art would recognize that modifications would come within the scope of this invention. For that reason, the following claims should be studied to determine the true scope and content of this invention.

1. An elevator comprising:
an elevator car movable along car guide rails;
a counterweight movable along counterweight guide rails;
a bedplate supported by at least one of said car and counterweight guide rails; and
a machine supported by said bedplate and driving a tension member interconnecting said counterweight and said car, opposed ends of said tension member being connected at dead end hitches, said bedplate having a vertically lowermost surface, and said dead end hitches extending above said vertically lowermost surface.

2. An elevator as set forth in claim 1, wherein said dead end hitches are mounted on said bedplate.

3. An elevator as set forth in claim 2, wherein said bedplate is formed by at least one beam, and said dead end hitches are supported by a vertically uppermost portion of said beam.

4. An elevator as set forth in claim 2, wherein said bedplate is formed by a pair of C-shaped beams each having an internal space and at least one of said dead end hitches is positioned within said internal space.

5. An elevator as set forth in claim 1, wherein said bedplate is supported by both of said car and counterweight guide rails.

6. An elevator as set forth in claim 1, wherein there are a plurality of said tension members and two sets of a corresponding plurality of dead end hitches, said dead end hitches of each of the two sets being aligned in an array that is generally parallel to a rotational axis of said machine.

7. An elevator as set forth in claim 6, wherein each of said sets of dead end hitches is disposed on opposed lateral sides of said rotational axis of said machine.

8. All elevator as set forth in claim 6, wherein said machine comprises a traction sheave having a plurality of sheave surfaces for engaging and driving the plurality of tension members, and said dead end hitches are disposed within an axial distance defined by ends of the traction sheave.

9. An elevator as set forth in claim 8, wherein each of said sheave surfaces is aligned with a respective one of said dead end hitches in each of said sets of dead end hitches such that a line drawn through one of the sheave surfaces and its two associated dead end hitches is perpendicular to said rotational axis.

10. An elevator as set forth in claim 1, wherein said machine comprises a traction sheave having a plurality of sheave surfaces for engaging and driving a plurality of said tension members, the opposed ends of each of said tension members being connected at a pair of the dead end hitches, wherein each of said sheave surfaces is aligned with a respective pair of the dead end hitches such that a line drawn through one of the sheave surfaces and its two associated dead end hitches is perpendicular to a rotational axis of the traction sheave.

11. An elevator comprising:
an elevator car movable along car guide rails;
a counterweight movable along counterweight guide rails;
a bedplate supported by at least one of said car and counterweight guide rails; and
a machine supported by the bedplate and driving a plurality of tension members interconnecting said counterweight to said car, opposed ends of said tension members being connected at dead end hitches, there being two sets of aligned dead end hitches, each set of dead end hitches being supported by the bedplate in an array that is generally parallel to a rotational axis of said machine.

12. An elevator as set forth in claim 11, wherein each of said sets of dead end hitches is disposed on opposed lateral sides of said rotational axis of said machine.

13. An elevator as set forth in claim 11, wherein said machine comprises a traction sheave having a plurality of sheave surfaces for engaging and driving the plurality of tension members, and said dead end hitches are disposed within an axial distance defined by ends of the traction sheave.

14. An elevator as set forth in claim 13, wherein each of said sheave surfaces is aligned with a respective one of said dead end hitch in each of said sets of dead end hitches such that a line drawn through one of the sheave surfaces and its two associated dead end hitches is perpendicular to said rotational axis.

15. The elevator according to claim 11, wherein the bedplate is supported by both of the car and counterweight guide rails.

16. An elevator comprising:
an elevator car movable along car guide rails;
a counterweight movable along counterweight guide rails;
a bedplate supported by at least one of said car and counterweight guide rails; and
a machine supported by the bedplate and comprising a traction sheave for engaging and driving a plurality of tension members interconnecting said counterweight to said car, opposed ends of said tension members being connected via dead end hitches to said bedplate,
the traction sheave having a plurality of sheave surfaces corresponding to the plurality of tension members, wherein each of said sheave surfaces is axially aligned with a respective pair of the dead end hitches such that a line drawn through one of the sheave surfaces and its two associated dead end hitches is perpendicular to a rotational axis of the traction sheave.

17. The elevator according to claim 16, wherein the bedplate is supported by both of the car and counterweight guide rails.
